(19) United States
(12) Patent Application Publication
(10) Pub. No.: US 2021/0051176 A1
(43) Pub. Date: Feb. 18, 2021

(54) SYSTEMS AND METHODS FOR PROTECTION FROM PHISHING ATTACKS

(71) Applicants: Salvatore J. Stolfo, New York, NY (US); Shlomo Hershkop, Philadelphia, PA (US)

(72) Inventors: Salvatore J. Stolfo, New York, NY (US); Shlomo Hershkop, Philadelphia, PA (US)

(21) Appl. No.: 16/995,783

(22) Filed: Aug. 17, 2020

Related U.S. Application Data
(60) Provisional application No. 62/894,799, filed on Sep. 1, 2019.
(60) Provisional application No. 62/888,477, filed on Aug. 17, 2019.

(51) Int. Cl. H04L 29/06; G06N 20/00; G06K 9/62

(52) U.S. Cl. CPC H04L 63/1491; G06K 9/6256; G06N 20/00; H04L 63/1483

(57) ABSTRACT

Systems and methods used to thwart attackers' attempts to steal digital credentials from computer network users and protect users from credential and identity theft via website spoofing and phishing campaigns.

### CROSS-REFERENCE TO RELATED APPLICATIONS

This application claims the benefit of U.S. Provisional Patent Application No. 62/888,477, filed on Aug. 17, 2019, and U.S. Provisional Patent Application No. 62/894,799, filed on Sep. 1, 2019. The entire contents of these applications are incorporated herein by reference.

### BACKGROUND OF THE INVENTION

A website is “spoofed” when a copy of a legitimate site is hosted on an illegitimate, unauthorized site. When attackers set up a spoofed website (also referred to herein as a “phishing website”), their primary intent is to “phish” for information from users who are enticed to visit the site through various means, such as sending a link to the spoofed site via email to a victim user through a “targeted” or “broad based” phishing campaign. For attackers to gather user credentials, they typically incur little to no cost, but they can immediately take possession of anything of value those credentials can access at legitimate websites. Banks, financial institutions, and their customers are primary targets of attackers, because money can be stolen by the internet enabled attacks.

Attackers may entice victims to visit a spoofed website by selecting for the spoofed website a URL name similar to the URL name of the legitimate website that was copied. For example, if the legitimate website is named “Bank.com”, the spoofed website may be given the URL, “MyBank.com”. A user may not notice the distinction between the URL of the legitimate website and the URL of the spoofed website. A user may therefore believe they have visited a legitimate website when, in fact, they visit a spoofed website. The user may attempt to log in to the spoofed website, thereby providing their credentials, which may be captured by the attacker who created the spoofed website. Furthermore, the spoofed website may also convince the user to provide Personally Identifiable Information (PII), such as social security numbers, bank account numbers, PIN numbers, credit card numbers, and a host of other of sensitive and private information.

Some solutions to this problem include searching DNS registry, domain name registration databases, and using information in globally accessible databases to determine if a new hosting site is confusingly similar to a legitimate website or otherwise seems suspicious. For example, the URL “MyBank.com” may be identified as suspicious if it is a new domain name not authorized or owned by “Bank.com”. This approach requires sophisticated analysis such as applying machine learning and natural language processing techniques to identify “suspicious” new domain names. The process can detect spoofed website names before the sites are exposed to victims, but may have a high false positive rate (incorrect attribution of a suspicious name or incorrect classification of an illegitimate site as legitimate) or a false negative rate (missing a suspicious domain name used as a spoofed domain). Information concerning current techniques is available at https://0xpatrik.com/phishing-domains/. A recent paper observes DNS monitoring is only approximately 28% accurate in detecting phishing websites.” See Oest, A, Zhang, P, Wardman, B, Nunes, E, Burgis, J, Zand, A, Thomas, K, Doupe, A, and Ahn, G, ‘Sunrise to Sunset: Analyzing the End-to-end Life Cycle and Effectiveness of Phishing Attacks at Scale’, Arizona State University.

“Beacons” embedded in documents have been used to track document locations on a network (including the broader internet) and decoy information to detect, trap or respond to attackers, whether they are “inside” an enterprise network, or external remote attackers seeking to attack sites and steal or destroy information. Prior work includes the teachings of U.S. Pat. Nos. 8,528,091; 8,819,825; 9,009,829; 9,356,957; and 9,501,639, which are incorporated herein by reference. Much of the prior work and issued patent disclosures describe embedding beacons in “documents”, using a variety of techniques such as any media requiring a “monitored network resource” (a remote image, font, certificate, . . . ) and any remote object fetched in order to process or render the document. The fetching of the object is a monitored activity and when a remote network resource is accessed, IP address and derivative geolocation information is logged and a decision process determines whether the event is indicative of a security violation. Furthermore, the network “signal” also captures the client IP address that accessed and rendered the document. Various methods may be used to embed a beacon in a document, including the use of Javascript.

### SUMMARY OF THE INVENTION

The present invention is directed to end-to-end systems and methods that may be used to thwart attackers' attempts to steal digital credentials from computer network users and protect users from credential and identity theft via web site spoofing and phishing campaigns. The present invention does not require end users to install client side software or browser extensions and is scalable to a large population of potential victim users.

One object of the present invention is to use beacons to identify an illegitimate website, such as a spoofed website, irrespective of its domain name. The use of beacons may avoid the false positive identification of an illegitimate website if the illegitimate website is generated by making a wholesale copy of a legitimate website, including beacons embedded in the legitimate website.

It is generally difficult to determine how many users may have been victimized by a spoofed website. The use of beacon signals, allows this information to be gathered, and provides quantifiable information of value to the owner of the legitimate website regarding the extent and details of customer credentials stolen by the attackers. This quantifiable threat intelligence may also be provided to user of the legitimate website to warn of potential losses from customer accounts.

It also an object of the present invention to devalue the PII and credentials stolen by attackers. One aspect of the systems and methods disclosed herein involves supplying to a spoofed website deceptive decoy PII and decoy credentials by, for example, form filling, whether automatic (preferred) or by hand. Automated form filling may be available for certain websites to automate the tedious process of supplying user login and financial or PII information by hand.

It is also an object of the present invention to not only detect spoofed websites, but to identify victim users who have visited those websites. It is a further objection of the present invention to gather victim user information to quantify the exposure of the attack and inform victim users to change their credentials.

Another aspect of the systems and methods disclosed herein is to gather “ground truth” data about phishers when they misuse decoy credentials. This data may be used as training data for a machine learning algorithm to model the behavior of phishers which may aid in “enhanced attribution”, identification of the phisher when correlated with other data. A recent government report, the Cyberspace Solarium Commission, specifically calls out “enhance attribution” as a key desiderata to shape the behavior of actors on the internet to make it more secure.

Another aspect of the systems and methods disclosed herein is to gather “ground truth” data when decoy credentials are misused to classify user access as either “phished” (e.g., having fallen victim to a spoofed website) or “normal.”

### BRIEF DESCRIPTION OF THE DRAWINGS

A further understanding of the invention can be obtained by reference to exemplary embodiments set forth in the illustrations of the accompanying drawings. Although the illustrated embodiments are merely exemplary of systems, methods, and apparatuses for carrying out the invention, both the organization and method of operation of the invention, in general, together with further objectives and advantages thereof, may be more easily understood by reference to the drawings and the following description. Like reference numbers generally refer to like features (e.g., functionally similar and/or structurally similar elements).

The drawings are not necessarily depicted to scale; in some instances, various aspects of the subject matter disclosed herein may be shown exaggerated or enlarged in the drawings to facilitate an understanding of different features. Also, the drawings are not intended to limit the scope of this invention, which is set forth with particularity in the claims as appended hereto or as subsequently amended, but merely to clarify and exemplify the invention.

FIG. 1 depicts a flow chart in accordance with the present invention;

FIG. 2 depicts a flow chart in accordance with the present invention;

### DETAILED DESCRIPTION OF THE INVENTION

The invention may be understood more readily by reference to the following detailed descriptions of embodiments of the invention. However, techniques, systems, and operating structures in accordance with the invention may be embodied in a wide variety of forms and modes, some of which may be quite different from those in the disclosed embodiments. Also, the features and elements disclosed herein may be combined to form various combinations without exclusivity, unless expressly stated otherwise. Consequently, the specific structural and functional details disclosed herein are merely representative. Yet, in that regard, they are deemed to afford the best embodiments for purposes of disclosure and to provide a basis for the claims herein, which define the scope of the invention. It should also be noted that, as used in the specification and the appended claims, the singular forms “a”, “an”, and “the” include plural referents unless the context clearly indicates otherwise.

Use of the term “exemplary” means illustrative or by way of example, and any reference herein to “the invention” is not intended to restrict or limit the invention to the exact features or steps of any one or more of the exemplary embodiments disclosed in the present specification. Also, repeated use of the phrase “in one embodiment,” “in an exemplary embodiment,” or similar phrases do not necessarily refer to the same embodiment, although they may. It is also noted that terms like “preferably,” “commonly,” and “typically,” are not used herein to limit the scope of the claimed invention or to imply that certain features are critical, essential, or even important to the structure or function of the claimed invention. Rather, those terms are merely intended to highlight alternative or additional features that may or may not be used in a particular embodiment of the present invention.

For exemplary methods or processes of the invention, the sequence and/or arrangement of steps described herein are illustrative and not restrictive. Accordingly, it should be understood that, although steps of various processes or methods may be shown and described as being in a sequence or temporal arrangement, the steps of any such processes or methods are not limited to being carried out in any particular sequence or arrangement, absent an indication otherwise. Indeed, the steps in such processes or methods generally may be carried out in various different sequences and arrangements while still falling within the scope of the present invention.

Webpages (e.g., HTML documents) may be embedded with beacons that can track whenever the website is browsed and rendered on a device. The logging of a monitored beacon signal can be used to identify security violations, such as whether the webpage has been spoofed. Identifying a spoofed website may be accomplished by comparing the webpage hosted IP address of a legitimate server, with the server IP address captured with the beacon signal. An unauthorized server IP address indicates an unauthorized spoofed website has been detected. The client IP address may also be captured, which can be used to identify the endpoint device that rendered the html document via a browser, for example, which is different than other embedded network communication within dynamic webpages.

Decoy credentials are fake but believable login credentials consisting of a variety of fields of information required to gain access to a website, such as login IDs (e.g., first names, last names, full names, email addresses and other Personally Identifiable Information), addresses, phone numbers, account numbers, and other tokens required for authentication at user login. Known techniques exist for automatically generating believable decoy information, including decoy credentials. The present invention includes another method for generating decoy credentials that are fake, unable to be used for login, but yet appear convincingly real.

When a user attempts to log in to a website but fails to provide accurate information, a failed login attempt may be noted. Additionally, or alternatively, the credentials used may be captured, stored, and/or used later as decoy credentials. All other relevant information, such as audit information provided by web logs, may also be stored and associated with the credentials of the user who provided the failed login credentials. A machine learning algorithm may also be used to associate the stored information with the credentials of the user. Accordingly, a failed login attempt may establish a relationship between a bogus but believable credential with a real user and associated audit information.

According to the present invention, one method for detecting a spoofed website involves embedding a “passive beacon” or “watermark” in one or more images on the original website. If an attacker copies images from the original website to create a spoofed website, the images, embedded with one or more passive beacons or watermarks, may facilitate automated monitoring and searching (for example Google indexing) for such spoofed websites.

Other means of detecting spoofed websites may also be used. For example, domain name registry analysis, or user communication or automated analysis of email and link analysis, alerting that they have detected an attacker's spoofed site. Another method for detecting spoofed websites involves referrer information in web requests. When a victim user is lured to a phishing website and enters their login credentials, the phishing website may automatically log into the legitimate website and input the credentials supplied by the victim user. To log into the legitimate website, the phishing website's server would contact the legitimate website and login in with the newly stolen credentials. The legitimacy of the credentials are thereby tested, and the attacker may receive any responses from the legitimate website that the victim would expect to receive. When the login request is made, the http log information would include the “referrer” IP address, in this case the phishing website's IP address. This referrer information can be retrieved from the web logs at the legitimate website and serves as another source of URL addresses that can be tested for spoofed websites.

Another method for detecting spoofed websites involves crowdsourcing. When a customer of a legitimate website receives a phishing email or a phishing SMS text message (known as Smishing) that purports to originate from the owner of the legitimate website or company, and the customer is suspicious of the email's authenticity or the text messages' authenticity, they may forward the email or the text message to the legitimate website using, for example, a known security and fraud email address (e.g., phishing@citi.com or a text message number for receiving customer suspect text messages. The URL's from the suspicious emails or texts may be extracted and checked to see whether they are associated with a spoofing website.

The client IP addresses of victim users who visit a spoofed website may be collected from embedded beacons copied to the cloned website. Additionally, or alternatively, a victim user may be identified by dropping cookies on the victim client machine when it visits the spoofed illegitimate site. Specifically, a beacon embedded in the webpage may drops a cookie on the endpoint device that browsed and rendered the spoofed webpage. A unique cookie may be calculated and placed in “container X” which encodes the unique hash and domain name and other information about the server and client. The cookie may then be used to identify victims and as a “signal source”.

When the victim user later visits the legitimate site, the container may be checked for a list of unique domain names captured and placed in the cookie when it was dropped on the client. If the domain names in the list don't match the legitimate site domain name, a direct callback signal serving as a beacon signal, and/or an indirect lookup (like a DNS beacon) may be generated, indicating the user was phished and visited an illegitimate spoofed site. The user may be alerted that they visited a spoofed website with the same cookie and unique hash. For example, the legitimate website interface can be configured to pop up an alert or warning to the user, for example to immediately change their login credentials. The website interface may also provide the user with the option to talk to customer service. Additionally, or alternatively, a user's account or other information may be noted as potentially accessed by an attacker.

Having the user/browser/client call back a beacon signal additionally provides protection for the beacons embedded in webpages, an issue faced when sophisticated attackers attempt to remove beacons, especially if they don't pay attention to the cookie system which may be encoded to appear like normal cookie markups.

When a spoofed website is detected, or the victim user is detected by the cookie-based beacon signal, mitigation and response may be the next considerations. An organization may attempt to “take down” the illegitimate spoofed website. The extent to which a spoofed website may be taken down, or the time expended while doing so, may depend upon the willingness of the relevant ISP's and the owners of the server domains to take down the offending site. Also, if an attacker exploits legitimate but vulnerable server sites to embed their spoofed sites, taking down the server sites may not be easily achievable. The time between detection of the spoofed site, and the successful “take down” operation is an open window of opportunity for attackers to gather victim user credentials. The “Sunrise to Sunset” paper discussed above observes phishing sites may operate for long periods of time before they are detected, and takedown operations may take days or longer before a site is taken down, if ever.

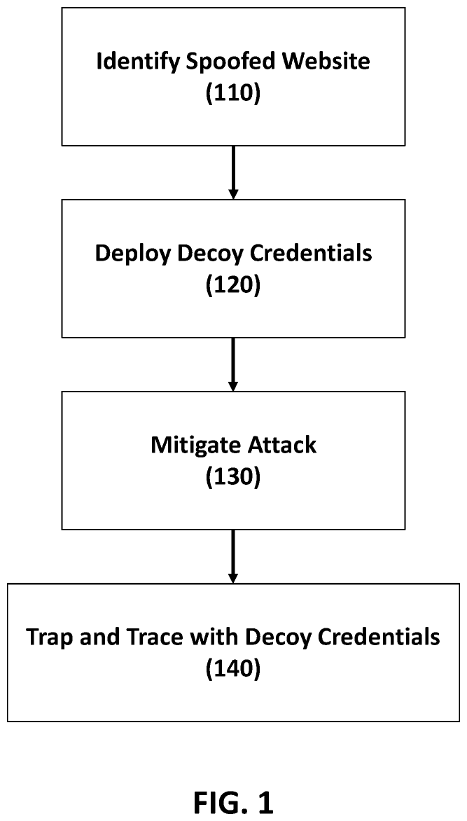

FIG. 1 depicts an end-to-end solution in accordance with the present invention. The systems and methods in accordance with the present invention may be used to mitigate and protect consumers and users against credential theft from phishing campaigns, especially those that utilize spoofed websites. Data generated and gathered may be used to classify the use of legitimate user credentials as either legitimate or misused by an attacker. This is accomplished by generating a model from a machine learning algorithm that inputs this data and generates a classifier.

Referring to FIG. 1, at Step (110) a spoofed website is identified. Identification may be accomplished as discussed above, by for example the use of web page beacons copied by the attacker, or by searching for passive beacons embedded in images copied by the attacker from the original legitimate site. A spoofed website may also be identified by other means such as DNS data, or certificate or domain name data.

At Step (120), once an illegitimate site is detected, the next phase depicted by the second block labeled “Deception” occurs next. To devalue the data stolen by the attacker, decoy credentials, such as decoy credentials generated according to methods disclosed in U.S. Pat. No. 10,476,908, are provided, either automatically or by manual entry, to the spoofed site. The decoy credentials may be fake but believable login credentials.

The creation of decoy credentials may involve creating a new email account at a service provider (such as a Gmail email address) and password. To create a valid email address, however, service providers often require a phone number as a second factor for authentication to verify the user. Hence, creating a decoy credential may require also generating a phone number capable of receiving SMS messaging, such Google voice. The phisher may test the legitimacy of stolen credentials, such as a Gmail account, and attempt to log in to the account at the legitimate website to test the authenticity of the credentials. They may also test the credentials at a website such as Facebook to determine whether there is also a social network account associated with the Gmail account as further evidence of its authenticity. Hence, when creating decoy credentials, such accounts may be created prior to stuffing them at a phishing site to make them highly believable and authentic. These created accounts are also used to gather additional information about the phisher as they may sell them or misuse them in other scams.

Decoy credentials generated as email accounts are also useful to gather any emails sent to the email accounts, and any ads received at social networking sites associated with the email accounts. These emails and ads may be phishing emails containing phishing URL's and phishing or scam ads or messages containing URL's linking to malicious sites. Hence, when the decoy credentials are created, the email accounts and the social networking accounts may be monitored for misuse by the phisher, and URL's extracted from received emails and ads may lead to malicious websites.

When decoy credentials are provided to an attacker's spoofed website, their set of stolen credentials may then include both legitimate, stolen credentials and fake decoys. Providing decoy credentials to the spoofed website therefore may “poison” the set of stolen credentials, because the attacker would be faced with the daunting and potentially expensive task of determining which credentials are real and which are fakes. This scenario imposes a cost for the attacker, and logically changes the balance of power an attacker typically enjoys.

An attacker may use their credentials for their target goal, or to test the set of stolen credentials to distinguish the real credentials from the fake. The attacker would thereby attempt to use the credentials to login at a legitimate website. Computer software at the legitimate website may monitor for the use of decoy credentials.

When the software detects a decoy credential being used at the website, the software may log various data, such as IP addresses, user agent strings (including server string), referrer string, protocol, and/or time of day. Using that data, a machine learning algorithm may be employed to model and predict how decoy credentials are used. Various data logged by Web accesses, such as IP addresses, user agent strings (including server string), referrer string, protocol, time of day, etc. are logged and serves as features for an ML modeling phase. The same set of information and features may be derived from “normal” user access to the legitimate site.

The use of decoy credentials generates attacker centric data as described above which may be classified as attacker data. The use of normal credentials by legitimate users generates similar types of data which may be classified as normal data. Attacker data and normal data may be input to a machine learning algorithm to generate a model that may be used to predict whether a user of a legitimate website is an attacker, even if the attacker does not use decoy credentials to access the legitimate website.

At Step (130) the attack may be mitigated. Mitigation refers to one or more actions that may be taken. These actions may be performed at the legitimate site, or by a third party provider such as a Content Distribution Network. Mitigation may include, for example, the stuffing of decoy credentials, blocking access to the illegitimate spoofed site, executing site takedown operations, and/or sending one or more “cease and desist” communications to the offending site operators or ISP.

At Step (140), decoy credentials may be monitored and, whenever used by an attacker, used to collect more information about the attacker (“trap and trace”), such as by attributing IP addresses under the control of the attacker. Decoy credentials may be linked with decoy account information to identify other accounts under the control of the attacker. These are generally referred to as “mule accounts” and are the primary means attackers steal money by transferred funds from a victim account. Decoy credentials may also be associated with decoy accounts for other services such as gaming sites, or retail sites, such as Amazon. The misuse of decoy accounts accessed by the decoy credentials provides information about the phisher's intent and may derive other information, such as addresses where they may attempt to ship items to, for example.

The present invention may be deployed by integrating with a legitimate website's web logs and other application logs that record failed login attempts. Relevant information about failed login attempts may be extracted from customer's logs and correlated against a database of decoy credentials generated and used by the present system. Thus, the use of decoy credentials may be detected without further user input.

A fake “decoy” account associated with predetermined information may be created for a legitimate website. For example, a decoy bank account may be created for a bank website. The decoy bank account may be associated with one or more decoy credentials, and may be assigned an account number and an account balance. When a decoy credential is used to access a legitimate website, the attacker may be granted access to the decoy account. If the attacker requests to interface the decoy account with a second account, such as a request to transfer funds, send a message, or establish a link to a second account, the legitimate website may monitor, track and record the request, the second account, and information related to the second account. In this way, allowing decoy credentials to access decoy accounts, may reveal information about the attackers and the accounts they own or control, so called “mule accounts”. It may also identify unwitting third parties whose accounts are also under the control of the attacker, for example, as a conduit to move money. Decoy credentials linked to decoy accounts may therefore provide a means to “following the money” associated with illegal transactions and identify perpetrators of fraud.

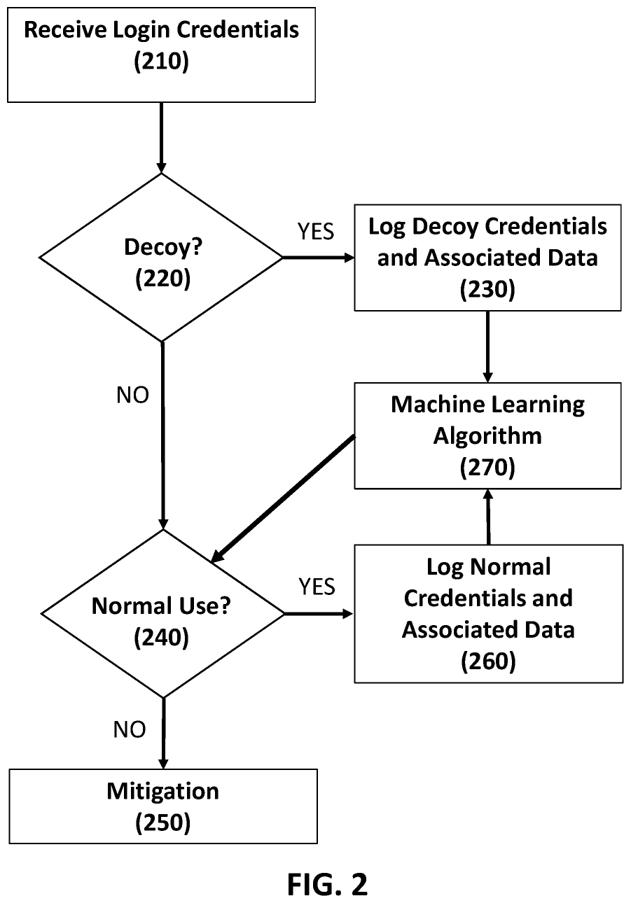

FIG. 2 depicts a flow chart disclosing further processing steps that may be performed by a computer device or computer system in accordance with the present invention. At step (210), login credentials are received and monitored by a legitimate website. The login credentials may be a login attempt by an attacker using decoy credentials, a login attempt by an attacker using stolen credential of a normal user, or a login attempt by a normal user using their own normal credentials.

At Step (220), the system determines whether the login credentials are decoy credentials. The determination of whether the login credentials are decoy credentials may be made, for example, by comparing the decoy credentials entered by the attacker to a list or database of decoy credentials. The list or database of decoy credentials may be stored in non-transitory memory of the computer device or computer system, or may be stored in non-transitory memory in a different device or system that may be accessed by the device or system practicing the present invention. Alternatively, the login credentials may be identified as decoy credentials based on a predetermined signal in the decoy credentials, such as a numerical code or a domain name of an email address that has been used to create the decoy credentials.

If the login credentials are identified as decoy credentials, at Step (230) the decoy credentials may be logged, additional data relating to decoy credentials or login attempt may be logged, and the decoy credentials may be associated with the additional data, for example, in a database or table.

At Step (270), the data logged at Step (230) may be used to generate a model or set of models from one or more machine learning algorithms using known techniques. The data logged at Step (230) may be used to help “train” a machine learning algorithm to predict whether login credentials are submitted by an unauthorized user of the credentials (i.e., an attacker).

If the login credentials are not identified as decoy credentials at Step (220), at Step (240) the system may determine whether information associated with the credentials, such as the IP address of the user's computer, the time of day at which the credentials are submitted, and/or other information provided or associated with the credentials, are consistent with information stored at the legitimate website and associated with the legitimate credentials, i.e., “normal” use. Additionally, or alternatively, the machine learning algorithm generated at Step (270) may be used to predict whether the login credentials were submitted by an unauthorized user.

If the login is determined to be a normal use, at Step (260) the credentials and data associated with the login may be logged. Returning to Step (270), data logged at Step (260) may be used to generate a machine learning algorithm model or set of models using known techniques. The data logged at Step (260) may be used to help “train” a machine learning algorithm to predict whether login credentials are submitted by an authorized user of the credentials. Additionally, or alternatively, a machine learning algorithm model or set of machine learning algorithm models may be generated using both the data logged at Step (230) and the data logged at Step (260), according to known techniques. The data logged at Step (230) may be used to train a machine learning algorithm to predict unauthorized use of login credentials, and the data logged at step (260) may be used to train the machine learning algorithm to predict authorized use of login credentials. One or more of the machine learning algorithms generated at Step (270) may be used to evaluate the login credentials and/or associated information at Step (240).

At Step (250), whenever an attacker presents stolen, legitimate credentials to a legitimate website, the machine learning algorithm model generated as described above for Step (270) may be used to predict whether aspects of the login (e.g., IP address from which the login credentials originated, time of day login credentials are submitted) indicate that the login is consistent with a normal user's use of their credentials, or whether aspects of the login indicate that the login is consistent with the use of decoy credentials, and therefore an indication that the credentials were submitted by an unauthorized user. If the machine learning algorithm model predicts that the login is likely presented are stolen credentials, steps to mitigate the theft may be implemented. For example, the user may be instructed to reset their password, rendering the stolen login credentials useless. The owner of the legitimate site may also be informed that they may be the victim of a spoofed website attack. Additionally, or alternatively, the “trap and trace” steps may be taken as described above to acquire information about the attacker's goals and any accounts to which they make a transfer or establish a link.

A system in accordance with the present invention may include a computer memory having a non-transitory machine-readable medium comprising machine-executable code recorded thereon, said machine-executable code comprising instructions for: (1) receiving requests to login to a website using a first set of login credentials; (2) determining whether each login credential in the first set of login credentials is a decoy credential; (3) for each login credential determined to be a decoy credential, logging the decoy credential and data associated with the login request as a first set of data; (4) for one or more login credentials not determined to be a decoy credential, logging the login credential and data associated with the login request as a second set of data; and (5) inputting the first set of data and second set of data into a machine learning algorithm to generate a model of the data. The machine-executable code may further include instructions for (a) determining whether each received login credential is a decoy credential by comparing each received login credential to a set of decoy credentials; and/or (b) determining whether each received login credential is decoy credential by comparing each received login credential to a predetermined signal. The machine-executable code may further include instructions for receiving one or more requests to login to the website using a second set of login credentials; and using the model generated by the machine learning algorithm to predict whether each login credential in the second set of login credentials is an unauthorized use of the login credential. The machine-executable code may further include instructions for generating an alert that an unauthorized user attempted to use the login credential.

While the invention has been described in detail with reference to embodiments for the purposes of making a complete disclosure of the invention, such embodiments are merely exemplary and are not intended to be limiting or represent an exhaustive enumeration of all aspects of the invention. It will be apparent to those of ordinary skill in the art that numerous changes may be made in such details, and the invention is capable of being embodied in other forms, without departing from the spirit, essential characteristics, and principles of the invention. Also, the benefits, advantages, solutions to problems, and any elements that may allow or facilitate any benefit, advantage, or solution are not to be construed as critical, required, or essential to the invention. The scope of the invention is to be limited only by the appended claims.

What is claimed is:

1. A method for protecting website users from phishing attacks, comprising:
embedding a beacon in an HTML document of a first website, wherein the first website is assigned to a first IP address;
generating a decoy credential;
receiving a beacon signal indicating a second IP address assigned to a second website;
comparing the first IP address to the second address; and
if the first IP address is not the same as the second address, inputting the decoy credential at the website located at the second IP address.

2. The method of claim 1, wherein the beacon signal further indicates the IP address of a device.

3. The method of claim 1, wherein the decoy credential comprises a login credential.

4. A method for detecting unauthorized users of login credentials, comprising:
receiving requests to login to a website using a first set of login credentials;
determining whether each login credential in the first set of login credentials is a decoy credential;
for each login credential determined to be a decoy credential, logging the decoy credential and data associated with the login request as a first set of data;
for one or more login credentials not determined to be a decoy credential, logging the login credential and data associated with the login request as a second set of data; and
inputting the first set of data and second set of data into a machine learning algorithm to generate a model of the data.

5. The method of claim 4, wherein the step of determining whether each received login credential is a decoy credential comprises comparing each received login credential to a set of decoy credentials.

6. The method of claim 4, wherein the step of determining whether each received login credential is a decoy credential comprises comparing each received login credential to a predetermined signal.

7. The method of claim 4, wherein the additional data associated with the login request is selected from a group consisting of audit information provided by a web log, an IP address, a user agent string, a referrer string, a protocol, and the time of day of the login request.

8. The method of claim 4, further comprising:
receiving one or more requests to login to the website using a second set of login credentials; and
using the model generated by the machine learning algorithm to predict whether each login credential in the second set of login credentials is an unauthorized use of the login credential.

9. The method of claim 8, further comprising the step of generating an alert that an unauthorized user attempted to use the login credential.

10. A system for detecting unauthorized users of login credentials, comprising:
a computer memory having a non-transitory machine-readable medium comprising machine-executable code recorded thereon, said machine-executable code comprising instructions for:
receiving requests to login to a website using a first set of login credentials;
determining whether each login credential in the first set of login credentials is a decoy credential;
for each login credential determined to be a decoy credential, logging the decoy credential and data associated with the login request as a first set of data;
for one or more login credentials not determined to be a decoy credential, logging the login credential and data associated with the login request as a second set of data; and
inputting the first set of data and second set of data into a machine learning algorithm to generate a model of the data.

11. The system of claim 10, wherein the machine-executable code further comprises instructions for determining whether each received login credential is a decoy credential by comparing each received login credential to a set of decoy credentials.

12. The system of claim 10, wherein the machine-executable code further comprises instructions for determining whether each received login credential is decoy credential by comparing each received login credential to a predetermined signal.

13. The system of claim 10, wherein the additional data associated with the login request is selected from a group consisting of audit information provided by a web log, an IP address, a user agent string, a referrer string, a protocol, and the time of day of the login request.

14. The system of claim 10, wherein the machine-executable code further comprises instructions for:
receiving one or more requests to login to the website using a second set of login credentials; and
using the model generated by the machine learning algorithm to predict whether each login credential in the second set of login credentials is an unauthorized use of the login credential.

15. The system of claim 10, wherein the machine-executable code further comprises instructions for generating an alert that an unauthorized user attempted to use the login credential.
